(19) United States
(12) Patent Application Publication
(10) Pub. No.: US 2018/0022888 A1
(43) Pub. Date: Jan. 25, 2018

(54) RECYCLING PROCESS FOR EXPANDED POLYSTYRENE WASTES

(71) Applicant: Nano and Advanced Materials Institute Limited, Hong Kong (HK)

(72) Inventors: Jifan Li, Hong Kong (HK); Tik Ho Lau, Hong Kong (HK); Ho-Yin Fong, Hong Kong (HK); Yuyan Song, Hong Kong (HK); Kai Li, Hong Kong (HK)

(21) Appl. No.: 15/216,739

(22) Filed: Jul. 22, 2016

(51) Int. Cl. C08J 11/08

(52) U.S. Cl. CPC C08J 11/08; C08J 2325/06

(57) ABSTRACT

Disclosed is an environmentally friendly recycling process for expanded polystyrene (EPS) wastes using dissolution process and supercritical CO₂ extraction process. The recycling process may enable condensing an expanded polystyrene (EPS) by dissolving the EPS into a solvent and one or more additives thereby obtaining an expanded polystyrene (EPS) solution. The recycling process may further enable purifying the EPS solution using at least one of a filtration process and a separation process in order to obtain a purified expanded polystyrene (EPS) solution. Further, the recycling process may further enable extracting the polystyrene from the solvent in the purified expanded polystyrene (EPS) solution using a supercritical CO₂ extraction method in order to obtain a recycled polystyrene. The recycling process enables in significant reduction of the volume of EPS thereby saving the logistical cost as well as facilitating increase in quantity, quality and purity of the recycled polystyrene.

### TECHNICAL FIELD

The present application in general relates to a process of recycling expanded polystyrene (EPS) wastes, and more particularly to an environmentally friendly and cost effective recycling process for EPS wastes using a dissolution process and supercritical CO₂ extraction process.

### BACKGROUND

Expanded polystyrene (EPS) is a rigid, tough, and closed-cell foam, which has multiple applications related to insulation and packing. EPS may be recycled to obtain recycled polystyrene. The existing recycling process faces many challenges. In the recycling process, usually the EPS wastes are transported from sources to factory sites where the EPS wastes are processed to obtain the desired recycled polystyrene. However, it has been observed that the cost required for the transport of the EPS wastes is extremely high. This is because, the EPS wastes have low density and large volume thereby tending to occupy huge spaces but with actual low contents. In an example, an EPS block (in 100×100×100 cm) with volume 1,000,000 cm³ weighs around 16 kg only. Therefore, the high transportation cost is a big hurdle to recycle EPS wastes.

Another technical challenge observed in the conventional recycling process is the condensation speed required for converting solid EPS wastes into dissolved form in solvent like limonene and cymene. The rate of the existing recycling process is not satisfying the needs of modern days when the solvent is used solely.

Existing practice in treating expanded polystyrene waste is by hot melting or incineration, which is not friendly to the environment and poor in efficiency as revealed by low extraction yield, high electricity demand and unavoidable toxins emission during the process.

### SUMMARY

Before the present process and its steps are described, it is to be understood that this application is not limited to the particular process and its steps as described, as there can be multiple possible embodiments which are not expressly illustrated in the present application. It is also to be understood that the terminology used in the description is for the purpose of describing the particular versions or embodiments only, and is not intended to limit the scope of the present application. This summary is not intended to identify essential features of the claimed subject matter nor is it intended for use in detecting or limiting the scope of the claimed subject matter.

A process for recycling an expanded polystyrene (EPS), including three distinct processes is disclosed. The process may include condensing an expanded polystyrene (EPS) by dissolving the EPS into a solvent and optionally with one or more additives thereby obtaining an expanded polystyrene (EPS) solution. The process may further include purifying the EPS solution using at least one of a filtration process and a separation process in order to obtain a purified expanded polystyrene (EPS) solution. Further, the process may include extracting the solvent from the purified expanded polystyrene (EPS) solution using a supercritical CO₂ in order to obtain recycled polystyrene.

In some embodiments, the solvent may be a green organic solvent including at least one of limonene, dipentene, cymene, anisole, cinnamaldehyde, phellandrene, linalool, pinene, terpinene and terpineol.

The one or more additives accelerate the dissolving process of the EPS. In some embodiments, the one or more additives may be selected from a group comprising ethanol, methanol, isopropyl alcohol, pentane, hexane and a mixture thereof. The one or more additives may be ethanol. In some embodiments, the volume ratio of the solvent to ethanol may be in the range of about 85:15 to about 80:20. The volume concentration of the one or more additives may be in a range of about 1% to about 50% and preferably about 1% to about 25%.

In some embodiments, the condensation process may be operated at a temperature within a range of about 20° C. to about 80° C.

The purification of the EPS solution using the filtration process enables removing solid contaminants and/or liquid contaminants from the EPS solution and the separation process enables removing liquid contaminants from the EPS solution.

In accordance with aspect of the present application, the supercritical CO₂ extraction method enabling the extraction of the EPS from the solvent is operated at a predefined temperature, a predefined pressure and a predefined gas flow. In some embodiments, the predefined temperature may be within a range of about 40° C. to about 80° C. The predefined pressure may be within a range of about 5 MPa to about 50 MPa. The predefined gas flow may be within a range of about 1 L/h to about 50 L/h. Moreover, the supercritical CO₂ extraction method further enables obtaining a recycled solvent in addition to the recycled polystyrene based upon the extraction of the EPS from the solvent in the EPS solution. The recycled solvent obtained may be further utilized as the solvent in the condensation of EPS.

These and other features, aspects, and advantages of the present application will become better understood with reference to the following description and appended claims.

### BRIEF DESCRIPTION OF DRAWINGS

The detailed description is described with reference to the accompanying Figures. In the Figures, the left-most digit(s) of a reference number identifies the Figure in which the reference number first appears. The same numbers are used throughout the drawings to refer like features and components.

FIG. 1 illustrates a flow diagram depicting steps of recycling process for EPS, in accordance with an embodiment of the present application.

FIG. 2 illustrates a filtration process employed for removal of dirt (solid contaminants), in accordance with an embodiment of the present application.

FIG. 3 illustrates a filtration process employed for removal of liquid contaminants in the EPS solution, in accordance with an embodiment of the present application.

FIG. 4 illustrates an extracted polystyrene using supercritical CO₂, in accordance with an embodiment of the present application.

### DETAILED DESCRIPTION

Some embodiments of this patent application, illustrating all its features, will now be discussed in detail.

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present application, the preferred, systems and methods are now described. The disclosed embodiments are merely exemplary of the present application, which may be embodied in various forms.

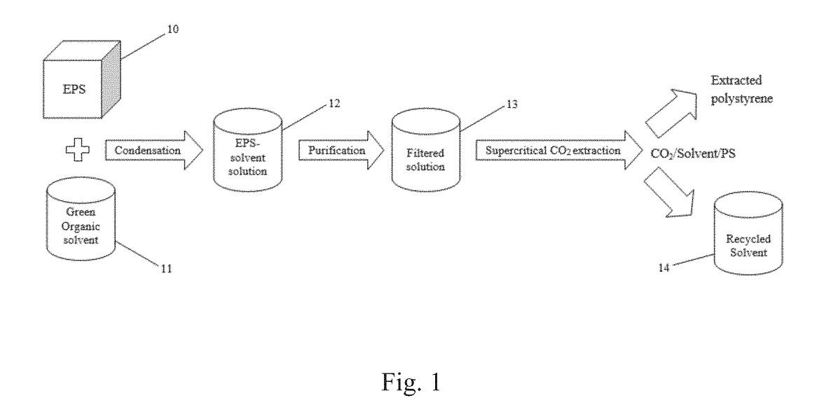

The present application discloses an environmentally friendly recycling process of expanded polystyrene waste, which solves the volume problem of polystyrene foamed materials and allows easy and inexpensive shipment of the polystyrene foamed materials after reduction of the volume. The recycling process produces a high quality, pure recycled polystyrene using supercritical CO₂ extraction method under specified temperature and pressure. The detailed description of the recycling process is further explained referring to FIGS. 1-4 below.

FIG. 1 is a flow diagram illustration steps of recycling process for EPS, in accordance with an embodiment of the present application. As shown, the recycling process for expanded polystyrene (EPS) wastes involves three steps including a condensing step using dissolution process, a purification step using at least one of filtration process and separation process, and an extraction step using supercritical CO₂.

Referring to FIG. 1, the condensing step using dissolution process includes dissolving the EPS waste 10 in a suitable solvent 11 capable of significantly dissolving EPS and forming an EPS-solvent solution 12 (also referred hereinafter as polystyrene solution) as shown in FIG. 1, thereby reducing the volume of EPS waste. In various embodiments, the suitable solvent may be a green organic solvent including at least one of limonene, dipentene, cymene, anisole, cinnamaldehyde, phellandrene, linalool, pinene, terpinene and terpineol. In one exemplary embodiment, the EPS waste 10 (shown in FIG. 1) is dissolved into limonene. It must be understood that limonene, being a natural solvent, may dissolve the EPS 10 easily so as to reduce the volume of the EPS 10 to less than 1/20 of original volume of the EPS waste 10. Therefore, the resultant EPS-solvent 12 (shown in FIG. 1) has a volume reduction of more than 20 times from the original size of the EPS waste 10.

It is to be noted that the dissolving rate in the aforementioned dissolution process may be further enhanced by dissolving the EPS waste 10 in the solvent 11 along with one or more additives. In some embodiments, the volume concentration of the one or more additives is in a range of about 1% to about 50%, and preferably about 1% to about 25%. In various embodiments, the one or more additives may be selected from a group consisting of ethanol, methanol, isopropyl alcohol (IPA), pentane, hexane and a mixture thereof. In one exemplary embodiment, the EPS waste 10 (shown in FIG. 1) is dissolved into ethanol along with limonene. It must be understood that with the addition of the additives like ethanol, the dissolving rate of the dissolution process is increased more than 100%, whereas the dissolution time is reduced by more than two times. The additives like ethanol further decreases the viscosity of the limonene solution and thereby leads to improve penetration of limonene solution into the expanded polystyrene (EPS).

It must be understood that the solvent 11 (e.g. limonene) before the dissolution process is originally transparent, clear and has lemon odor. After the condensation is completed, the EPS solution obtained is cloudy, viscous and has lemon odor. It is observed that by selecting the right solvents and additives, the volume of EPS waste may be significantly reduced and the dissolving time may be greatly shortened. The significant reduction in the volume of EPS further assists in reduction of the transportation cost. It is to be noted that the aforementioned dissolution process may be carried out under room temperature and pressure. Further, the dissolution process may be completed within about 2-3 hours to yield the EPS-solvent solution 12 with 40% of its weight extracted from EPS waste 10. In one embodiment, the condensation process is operated at a temperature within a range of about 20° C. to about 80° C.

Referring to FIG. 1, after the condensation step, the next step is the purification step involving at least one of the filtration process and the separation process for removing the contaminants from the polystyrene solution (i.e. EPS-solvent solution 12 shown in FIG. 1). In an embodiment, the filtration process may be employed in order to remove the solid contaminants (solid particles) from the polystyrene solution. Further, the separation process and/or filtration process may be employed in order to remove the liquid contaminants (liquid particles) from the polystyrene solution.

It is to be understood that the EPS waste 10 may be contaminated with dirt and liquids thereby affecting the quality of the recycled polystyrene. In case the EPS waste 10 collected is dirty, the resultant solution (i.e. EPS-solvent solution 12 shown in FIG. 1) containing the EPS waste 10 dissolved in the solvent 11 is full of contaminants. Such contaminants may not be extracted during the extraction step using supercritical CO₂ (explained in detail in subsequent paragraphs). The contaminants therefore may be present in the polystyrene obtained as outcome of the extraction step thereby reducing purity of the polystyrene. Thus, the purification step is performed on the polystyrene solution 12 by means of at least one of the filtration process and the separation process.

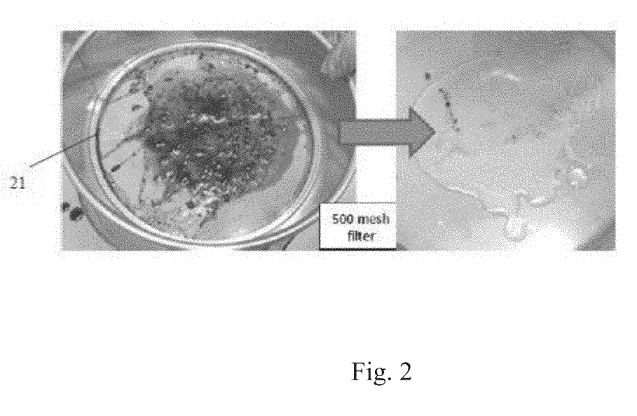

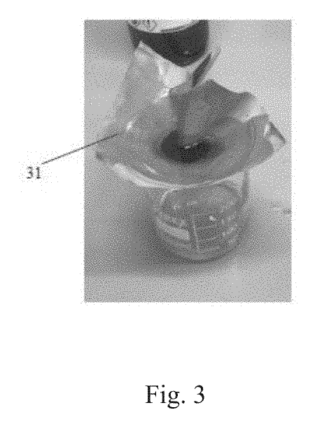

Referring to FIG. 2, the purification of the polystyrene solution 12 using the filtration process is shown, in accordance with an embodiment of the present application. As shown in FIG. 2, the filtration process is carried out using an appropriate filter 21 (e.g. 500 mesh sieve) capable of removing the solid contaminants from the polystyrene solution 12. Referring to FIG. 3, the purification of the polystyrene solution using the filtration process is shown, in accordance with an embodiment of the present application. As shown in FIG. 3, the filtration process is carried out using a filter 31 (e.g. 500 mesh sieve) to remove the liquid contaminants. Based on the purification of the polystyrene solution 12 using at least one of the filtration process and the separation process, a purified polystyrene solution or treated polystyrene solution (indicated as filtered solution 13 in FIG. 1) is obtained. The filtered solution may include no or little amount of contaminates which may have negligible effect on the quality of the final recycled polystyrene obtained as result of the extraction step explained in detail as below.

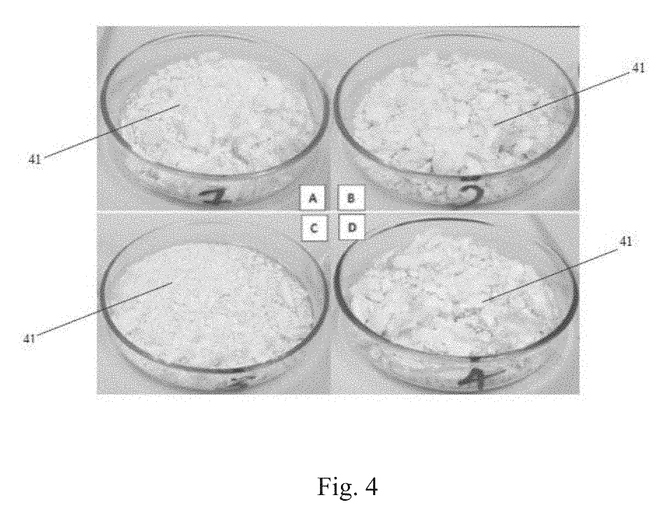

Referring to FIG. 1, after the purification step, the next step is the extraction step using supercritical CO₂ for separation of the polystyrene from the solvent in the filtered solution 13. In the extraction step, the filtered solution 13 is placed for supercritical CO₂ extraction for about 1-3 hours depending on the amount of dissolved polystyrene in the solution. Under specified temperature and pressure, CO₂ is in supercritical form, which can dissolve and carry away the solvent from the filtered polystyrene solution 13. The recycled solvent 14 may be reused for the condensation of EPS. In one embodiment, the extracted polystyrene is the polystyrene shown in FIG. 4.

It must be understood that the supercritical CO₂ extraction process is used to extract the solvent from the polystyrene solution. The equilibrium and solubility of the supercritical CO₂, solvent and polystyrene components in the ternary system are important factors in controlling the efficiency of the extraction process. Due to the low solubility of the polystyrene and high solubility of the solvent in supercritical CO₂, the supercritical CO₂ is used as an anti-solvent to separate solvent from the solution so as to make the extraction feasible. It is to be noted that pressure and temperature are both important parameters for the extraction process, which affect solubility of the solvent so as to affect the quality of the recycled polystyrene.

Generally, higher pressure leads to increased solubility; solubility is also likely to rise with increasing temperature (e.g. ˜60° C.) when the pressure is higher than a critical point. The efficiency of the extraction process is also governed by flow rate of supercritical CO₂, as the density of CO₂ changes along with varying temperatures. A high flow rate of supercritical CO₂ may ensure that the extraction is completely limited by diffusion but is inevitably wasteful of solvent. Therefore, efficiency of the extraction system is a delicate balance between maximizing the flow rate while minimizing the amount of solvent needed to be spent. For instance, at 60° C. and 150 bar, it takes approximately one hour to complete the extraction of polystyrene from solution. The extraction process can be speeded up by increasing the pressure, which leads to the increased solubility of the solvent in supercritical CO₂.

Based on the supercritical CO₂ extraction process, a high quality and pure polystyrene 41 (as shown in FIG. 4) may be obtained under predefined temperature, predefined pressure and predefined gas flow. In one embodiment, the predefined temperature is within a range of about 40° C. to about 80° C. In one embodiment, the predefined pressure is within a range of about 5 MPa to about 50 MPa. In one embodiment, the predefined gas flow is within a range of about 1 L/h to about 50 L/h. The extracted polystyrene 41 (shown in FIG. 4) has a higher molecular weight and a lower polymeric distribution index (PDI) as compared to the original EPS 10 shown in FIG. 1.

In accordance with an embodiment of the present application, the aforementioned recycling process is further described by referring to various examples as below.

### Example 1

The limonene as a solvent may dissolve large amount of EPS so as to reduce its volume. For instance, referring to Table 1 below, it is observed that the volume of 206 g EPS is around 12360 ml which may be reduced to 600 ml solvent solution 12 after dissolving in 500 ml of limonene i.e. organic solvent 11.

TABLE 1

| Volume of limonene | 500 | mL |
|---|---|---|
| Total weight of EPS dissolved | 206 | g |
| Percentage of EPS dissolved in 500 ml limonene | 41.2 wt % (~0.4 g/mL) | |
| Final volume of Limonene solution | 600 | mL |

In another embodiment, cymene may be used as an alternative solvent to Limonene. It is to be noted that -cymene has similar properties and capability as that of limonene. Table 2 below illustrates the performance of cymene in comparison to that of the limonene.

TABLE 2

| Solvent (20 mL) | Mass of EPS/g | Dimension | Time needed/s |
|---|---|---|---|
| Limonene | 0.117 | 1.8 × 1.8 × 1.8 cm | 68.7 |
| Limonene | 0.495 | 4.4 × 3.8 × 1.9 cm | 63.25 |
| cymene | 0.114 | 1.8 × 1.8 × 1.8 cm | 40.35 |
| cymene | 0.495 | 4.4 × 3.8 × 1.9 cm | 32.35 |

### Example 2

Some chemicals as the additives to the solvent could accelerate the dissolving process. As shown in the Table 3, when the additives are added to the solvent, the dissolving time may be significantly shortened.

TABLE 3

| | Weight of EPS Block ≈ 0.5 g | | | | |
|---|---|---|---|---|---|
| | | Size of EPS block: | | Volume of | |
| | | 4.4 × 3.8 × 1.9 cm | | Limonene = 20 ml | |
| | Volume concentration of additives | | | | |
| Additives | 0% | 1% | 2% | 3% | 4% |
| Ethanol | 40 s | 37 s | 37 s | 37 s | 34 s |
| Methanol | 40 s | 32 s | 31 s | 31 s | 28 s |
| Pentane | 40 s | 46 s | 28 s | 28 s | 29 s |
| Hexane | 40 s | 38 s | 39 s | 33 s | 34 s |

For high concentration of EPS solution, ethanol as the additive is more effective on reducing the dissolving time. To balance the efficiency and the damage to the environment, ethanol is considered as the best choice among others. As observed from Table 4 below, with the presence of 20% of ethanol in the solvent, the dissolving time is reduced by more than 3 times.

TABLE 4

| Limonene content | Ethanol content | Time | % Time |
|---|---|---|---|
| (vol %) | (vol %) | required/sec | difference |
| 100 | 0 | 569 | 0% |
| 85 | 15 | 280 | −51% |
| 80 | 20 | 164 | −71% |

To compromise with the efficiency and the demand of chemicals, the solvent: ethanol ratio=85:15 is considered as the most effective option which saves 50% of time needed.

### Example 3

It is necessary to remove the contaminants like dirt and other liquid from polystyrene solution before supercritical CO₂ extraction process for obtaining the high quality of recycled polystyrene. Filtration process is employed to remove those contaminants and purify the polystyrene solution. To remove the dirt from polystyrene solution by filtration, as shown in FIG. 2, a 500 mesh filter 21 is able to separate solid impurities and liquid impurities from the solution. To remove the liquid contaminations (like chili sauce and soy sauce) from polystyrene solution, it is well enough to use a filter with 500 mesh size.

### Example 4

The high quality of recycled polystyrene may be obtained from the polystyrene solution through supercritical CO₂ extraction process. While CO₂ is under certain temperature and pressure, it is in supercritical form, which may dissolve and carry away the solvent from the polystyrene solution. Thus, dry and pure polystyrene is left as the final recycled product (recycled polystyrene).

In addition to dry and pure polystyrene, as shown in FIG. 1, recycled solvent 14 is also obtained from the extraction process which can be reused for the condensation process.

TABLE 5

| | Experimental conditions | | | | | | | |
|---|---|---|---|---|---|---|---|---|
| Sample | Pressure | Temperature | Time | Volume | | | | |
| Name | (MPa) | (° C.) | (min) | (mL) | Mₙ | M_{w} | PDI | Remark |
| Sample A | 20 | 50 | 60 | 230 | 130,694 | 212,461 | 1.626 | Extracted PS |
| Sample B | 25 | 55 | 50 | 200 | 132,599 | 212,382 | 1.602 | Extracted PS |
| Sample C | 25 | 60 | 60 | 150 | 105,078 | 205,448 | 1.955 | Extracted PS |
| Sample D | 15 | 50 | 45 | 50 | 101,286 | 203,527 | 2.009 | Extracted PS |
| Sample E | 10 | 50 | 60 | 60 | 94,768 | 202,208 | 2.134 | Extracted PS |
| Sample F | 15 | 50 | 60 | 50 | 115,064 | 208,003 | 1.808 | Extracted PS |
| Original | — | — | — | — | 78,142 | 194,509 | 2.489 | Virgin PS |
| polystyrene | | | | | | | | |

The GPC results illustrated in Table 5 depicts that the extracted polystyrene has higher molecular weight and lower PDI as compared to the original polystyrene. Thus, the extraction process helps to remove the small molecule and impurity from the polystyrene so as to obtain the high quality of recycled polystyrene 41 as shown in FIG. 4.

Exemplary embodiments discussed above may provide certain advantages. Though not required to practice aspects of the application, these advantages may include those provided by the following features.

Some embodiments enable a recycling process for EPS facilitating shrinking the size of EPS blocks. According to the recycling process, with the aid of solvent, the size of EPS blocks may be shrunken by 20 times of its original volume.

Some embodiments enable a recycling process for EPS facilitating reduction in transportation cost due to reduction in volume and thereby improving the transportation efficiency.

Some embodiments enable a system and a method for increasing the speed of condensation process. The increase in the speed and thereby reduction in the time required for condensation process is enabled based upon addition additives such as ethanol and IPA which assists in reducing the time required by 50%. The improvement in the condensation efficiency saves time and thus saves cost.

Some embodiments enable a recycling process for EPS facilitating removal of solid and liquid impurities from the polystyrene solution so that the final recycled polystyrene is free from the contaminates and/or impurities.

Although embodiments for processes and methods of recycling an expanded polystyrene (EPS) have been described in language specific to structural features and/or methods, it is to be understood that the appended claims are not necessarily limited to the specific features or methods described. Rather, the specific features and methods are disclosed as examples of embodiments for recycling an expanded polystyrene (EPS).

What is claimed is:

1. A process for recycling an expanded polystyrene (EPS), comprising:
condensing an expanded polystyrene (EPS) by dissolving the EPS into a solvent thereby obtaining an expanded polystyrene (EPS) solution;
purifying the EPS solution using at least one of a filtration process and a separation process in order to obtain a purified expanded polystyrene (EPS) solution; and
extracting the solvent from the purified expanded polystyrene (EPS) solution using supercritical CO₂ in order to obtain a recycled polystyrene.

2. The process of claim 1, wherein the solvent is a green organic solvent comprising at least one of limonene, dipentene, cymene, anisole, cinnamaldehyde, phellandrene, linalool, pinene, terpinene and terpineol.

3. The process of claim 1, wherein one or more additives is added into the solvent for dissolving the EPS.

4. The process of claim 3, wherein the one or more additives are selected from a group comprising ethanol, methanol, isopropyl alcohol, pentane, hexane and a mixture thereof.

5. The process of claim 4, wherein the one or more additives comprise ethanol.

6. The process of claim 4, wherein the volume ratio of the solvent to ethanol is 85:15.

7. The process of claim 4, wherein the volume ratio of the solvent to ethanol is 80:20.

8. The process of claim 3, wherein the volume concentration of the one or more additives is in a range of 1% to 50% and preferably 1% to 25%.

9. The process of claim 1, wherein the condensation process is operated at a temperature within a range of 20° C. to 80° C.

10. The process of claim 3, wherein the one or more additives accelerates the dissolving process of the EPS.

11. The process of claim 1, wherein the purification of the EPS solution using the filtration process enables removing solid contaminants and/or liquid contaminants from the EPS solution.

12. The process of claim 1, wherein the purification of the EPS solution using the separation process enables removing liquid contaminants from the EPS solution.

13. The process of claim 1, wherein the supercritical CO₂ extraction method enabling the extraction of the solvent from the polystyrene solution is operated at a predefined temperature, a predefined pressure and a predefined gas flow.

14. The process of claim 13, wherein the predefined temperature is within a range of 40° C. to 80° C.

15. The process of claim 13, wherein the predefined pressure is within a range of 5 MPa to 50 MPa.

16. The process of claim 13, wherein the predefined gas flow is within a range of 1 L/h to 50 L/h.

17. The process of claim 1 further comprising obtaining a recycled solvent in addition to the recycled polystyrene, wherein the recycled solvent is further utilized as the solvent in the condensation of EPS.
